(19) United States
(12) Patent Application Publication
(10) Pub. No.: US 2008/0283688 A1
(43) Pub. Date: Nov. 20, 2008

(54) HOLDER

(75) Inventors: Hitoshi Kaneko, Tokyo (JP); Hisanori Kato, Tokyo (JP)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: YKK Corporation

(21) Appl. No.: 12/117,369

(22) Filed: May 8, 2008

(30) Foreign Application Priority Data
May 14, 2007 (JP) 2007-128028

(51) Int. Cl. F16L 3/08

(52) U.S. Cl. 248/74.1

(57) ABSTRACT

A holder is provided with a base, a first bent portion that extends from a first end of the base, and a second bent portion that extends from a second end of the base or the first bent portion. The first bent portion has a first engaging element that is engaged with an engaging concave of the base. The second bent portion has a second engaging element that is engaged with the engaging concave of the base. A first accommodating space within which an object is held by the base and the first bent portion and a second accommodating space within which an object is held by the base and the second bent portion are formed. A movement stopper is provided on at least one of the second bent portion and the second engaging element to prevent the movement of first engaging element in a disengaging direction.

### BACKGROUND OF THE INVENTION

1. Field of the Invention

The present invention relates to a holder. More specifically, it relates to a holder that holds, for example, long objects such as a string.

2. Description of Related Art

A bracelet, a necklace and the like which include a holder that holds long objects such as a plurality of strings in parallel are known as accessories.

Conventionally, for example as shown in FIG. 21, a holder 6 of a short column having oval cross-section and provided with two holes that penetrate the column, is known as a holder used for such accessories. After inserting each of two strings 7 that have distal ends through the holes of the holder 6 respectively, both distal ends of the strings 7 are sewn, bonded or jointed so that the strings can be arranged in a ring while being held in parallel.

As another example, a column-shaped clamp that holds and fixes long column-shaped objects is disclosed in JP-UM-B-4-16007.

This column-shaped clamp is provided on a stud bolt projectingly provided on an attachment surface to hold column-shaped objects along the attachment surface, which is constituted by a plastic body and a metal holding plate. The body is has a holding portion that holds column-shaped objects and a stud attachment hole drilled in a direction substantially orthogonal with the axial direction of the column-shaped objects and provided with an engaging step on the inner wall thereof. The holding plate is wound around the periphery of the body like a belt. The both ends of the holding plate can be inserted into the stud attachment hole. Both ends of the holding plate which can be inserted in the stud attachment hole are provided with a first engaging claw engaged with the engaging step and a second engaging claw engaged with a screw portion of the stud bolt inserted into the stud attachment hole in a non-return manner.

When the both ends of the holding plate is inserted into the stud attachment hole after inserting the column-shaped objects into the holding portion, the first securing claw is engaged with the engaging step of the stud attachment hole. When the stud attachment hole of the clamp is aligned with the stud bolt and the clamp is fitted with the stud bolt under this condition, a second engaging claw is engaged with the screw portion (screw head) of the stud bolt to be prevented from pulling-out. The column-shaped objects can be thus horizontally retained against the attachment surface.

However, in the holder shown in FIG. 21, the string has to be unfailingly inserted through the holder before the ends of the string are processed. Therefore, the ring-shaped string with no end cannot be inserted through the holder.

Further, in the clamp disclosed in the above-mentioned JP-UM-B-4-16007, enough engaging force cannot be obtained just by inserting the both ends of the holding plate into the stud attachment hole since it is only the first engaging claw that is engaged with the engaging step of the stud attachment hole. The stud bolt has to be inserted in the stud attachment hole to enhance the engaging force, which requires additional components and the number of components is thus increased.

### SUMMARY OF VARIOUS EMBODIMENTS OF THE INVENTION

An object of various embodiments of the invention is to provide a holder that can solve the above problems and enhance holding force while being able to hold a ring-shaped looped object.

A holder according to one embodiment of the present invention includes: a base that comprises a first engaged element and a second engaged element; a first bent portion that extends from a first end of the base and is bendable with respect to the base; and a second bent portion that extends from a second end of the base or the first bent portion and is bendable with respect to the base, in which: the first bent portion comprises a first engaging element that is engaged with the first engaged element of the base; the second bent portion comprises a second engaging element that is engaged with the second engaged element of the base; the first engaging element is engaged with the first engaged element to provide a first accommodating space within which an object is held by the base and the first bent portion; the second engaging element is engaged with the second engaged element to provide a second accommodating space within which an object is held by the base and the second bent portion; and at least one of the second bent portion and the second engaging portion comprises a movement stopper that prevents the first engaging element from moving in a disengaging direction.

According to the aspect of the invention, the first bent portion is bent with respect to the base firstly after the object to be held is placed inside the first bent portion and the second bent portion so that the first engaging element provided on the first bent portion is engaged with the first engaged element of the base. Then, the first accommodating space is formed by the base and the first bent portion to hold the object to be held.

Next, the second bent portion is bent with respect to the base so that the second engaging element provided on the second bent portion is engaged with the second engaged element of the base. Then, the second accommodating space is formed by the base and the second bent portion to hold the object to be held.

As above, even a ring-shaped looped string can be held.

Further, since at least one of the second bent portion and the second engaging element has a movement stopper that prevents the first engaging element from moving toward a disengaging direction, each of the engaging elements is not easily detached and the holding force can be accordingly enhanced.

For example, when an external force in a direction where the first engaging element is disengaged is applied on the first bent portion via the object to be held, the external force is applied also on the engagement portion of the second engaging element provided on the second bent portion and the second engaged element provided on the base via the movement stopper while being applied on the engagement portion of the first engaging element provided on the first bent portion and the first engaged element provided on the base. Since the first engaging element and the second engaging element can cooperatively share the external force, the first engaging element and the second engaging element cooperate to hold the object to be held under the pressure of the external force and are consequently less likely to be detached. Therefore, the holding force can be enhanced.

In this arrangement: the movement stopper comprises a third engaged element that may be preferably provided on the first bent portion and a third engaging element that is provided on the second bent portion and engaged with the third engaged element; one of the third engaged element and the third engaging element is formed by a convex and the other is formed by a concave that is engaged with the convex; and the convex and the concave are placed adjacently in the disengaging direction of the first engaging element.

In the above, since the movement stopper is constituted by the concave and the convex which are provided on the first bent portion and the convex and the second bent portion, for example, the concave or the convex provided on the first bent portion abut to the convex or the concave which are provided on the second bent portion to restrict the movement of the first bent portion when the first bent portion is biased to move in a direction where the first engaging element is disengaged by external force applied on the first bent portion via the object to be held. In this condition, since the convex and the concave are neighboring in the disengaging direction of the first engaging element, no torsion is applied on the first bent portion even when the concave and the convex are abutted with each other. Accordingly, the external force can be securely distributed to the second bent portion via the convex and the concave.

In this arrangement: the base may be preferably provided with an opening and an engaging concave is formed on a remote side of the opening; the first engaged element and the second engaged element are formed by the engaging concave; the first engaging element comprises a first stem that protrudes on a distal end of the first bent portion and a first engaging piece that extends on a distal end of the first stem in a crossing direction with respect to the direction where the first stem protrudes to engage with the engaging concave; and the second engaging element comprises a second stem that protrudes on a distal end of the second bent portion and a second engaging piece that extends on a distal end of the second stem in a crossing direction with respect to the direction where the second stem protrudes to engage with the engaging concave.

In the above, since the first engaged element and the second engaged element are formed by the engaging convex provided on the base and the first engaging element and the second engaging element include: the first stem and the second stem which respectively protrude on the ends of the first bent portion and the second bent portion; and the first engaging piece and the second engaging piece which protrude in the crossing direction with respect to the direction where each of the stems protrudes on each of the ends of the first stem and the second stem respectively, the first engaging piece and the second engaging piece are engaged with the engaging concave when the first bent portion and the second bent portion are bent with respect to the base, which facilitates the engaging operation of the first bent portion and the second bent portion. Further, in the engagement, since each of the engaging pieces which protrudes in the crossing direction with respect to the direction where each of the stems protrudes engages with the engaging concave, the engaging pieces are not easily disengaged.

In this arrangement, at least one of the first engaging piece and the second engaging piece may preferably include an extending portion that extends in two or more different directions.

In the above, since at least one of the first engaging piece and the second engaging piece has the extending portions that extend in more than two different directions to be engaged in more than two different directions, it is less likely to be disengaged even when external force in various directions is applied. Accordingly, the object to be held is securely held.

In this arrangement, the first engaging piece may preferably include an extending portion that extends in a crossing direction with respect to the extending direction of the second engaging piece.

In the above, since the first engaging piece has the extending portion that extends in the crossing direction (i.e. a direction different from the extending direction of the second engaging piece), in the same way as the above, it is less likely to be disengaged even when external force in various directions is applied. Especially, in such an arrangement, since the first engaging piece and the second engaging piece can share directions of the applied external force, the first engaging piece and the second engaging piece can be respectively designed in a shape and a configuration which meet the required functions to enhance design flexibility.

In this arrangement, when the first engaging element and the second engaging element are respectively engaged with the first engaged element and the second engaged element, the first engaging element and the second engaging element may be preferably located adjacently with each other, the first engaging element is engaged with the first engaged element by elastic deformation of the first bent portion, and the second engaging element is engaged with the second engaged element by elastic deformation of the second engaging piece.

In the above, since the first engaging piece is engaged with the first engaged element by elastic deformation of the first bent portion, a structure that prevents an easy detachment can be achieved by forming the first engaging piece in a thickness that allows no elastic deformation. However, it can be still detached since the first bent portion is elastically deformable.

The second engaging element is engaged with the second engaged element by elastic deformation of the second engaging piece. In the engagement, since the second engaging element abuts to the first engaging element, the first bent portion can be prevented from elastically deforming in a disengaging direction of the first engaging element. Therefore, the holding force can also be enhanced by this arrangement.

In this arrangement, the first engaging element and the second engaging element may be preferably formed adjacently in a central axial direction of at least one of the first accommodating space and the second accommodating space.

In the above, since the first engaging element and the second engaging element are neighboring to the central axial direction of the accommodating space, the second engaging element effectively works as a movement stopper for the first engaging element. Further, a compact shape of the holder can be realized.

In this arrangement, a third engaging element and a third engaged element may be preferably provided on a surface where the first engaging element and the second engaging element face to each other.

In the above, since the third engaging element and the third engaged element are formed on the surface where the first engaging element and the second engaging element face to each other (i.e. the engaging portions are concentrated at one position), the engaging operations can be done at the one position and the structure can be consequently downsized. Further, since engaging portions are not dispersed, shakiness of each portion can be reduced to enhance the overall strength.

In this arrangement: the second bent portion may preferably extends from a second end of the base; and the first bent portion and the second bent portion are molded inclining inward with each other and the first bent portion is molded inclining more inward than the second bent portion.

In the above, since the first bent portion and the second bent portion are inclined inward with each other, the engaging operation (i.e. bending operation of the first bent portion and the second bent portion relative to the base) can be facilitated. Further, the second bent portion can be subsequently bent after the first bent portion is bent since the first bent portion is inclined more inward that the second bent portion. In other words, the assembly operation can be done without mistaking the assembly steps.

In this arrangement, the first engaging element and the second engaging element may preferably extend toward the base respectively from each distal end of the first bent portion and the second bet portion.

In the above, since the first engaging element and the second engaging element protrude from each end of the first bent portion and the second bent portion to the base, the first engaging element and the second engaging element can be engaged with the first engaged element and the second engaged element of the base only by bending the first bent portion and the second bent portion against the base. Accordingly, the engagement can be significantly easily done.

### BRIEF DESCRIPTION OF THE DRAWINGS

FIG. 1 is a perspective view showing a holder before engagement according to an embodiment of the present invention.

FIG. 2 is a perspective view showing the holder after engagement according to the embodiment in FIG. 1.

FIG. 3 is a plan view showing the holder before engagement according to the embodiment in FIG. 1.

FIG. 4 is a view showing a condition in which one of bent portions of the holder according to the embodiment in FIG. 1 is engaged.

FIG. 5 is a cross section taken along V-V line in FIG. 4.

FIG. 6 is a central horizontal cross section showing the holder according to the embodiment in FIG. 1.

FIG. 7 is a central vertical cross section showing the holder according to the embodiment in FIG. 1.

FIG. 8 is a cross section taken along VIII-VIII line in FIG. 5.

FIG. 9 is a plan view showing a holder before engagement according to another embodiment of the present invention.

FIG. 10 is a cross section taken along X-X line in FIG. 9.

FIG. 11 is a cross section taken along XI-XI line in FIG. 9.

FIG. 12 is a cross section taken along XII-XII line in FIG. 9.

FIG. 13 is a view showing a condition in which one of bent portions of the holder according to the embodiment in FIG. 9 is engaged.

FIG. 14 is a cross section taken along XIV-XIV line in FIG. 13.

FIG. 15 is a partial cross section showing the holder after engagement according to the embodiment in FIG. 9.

FIG. 16 is a cross section taken along XVI-XVI line in FIG. 15.

FIG. 17 is a plan view showing a holder before engagement according to another embodiment of the present invention.

FIG. 18 is a plan view showing a holder before engagement according to the embodiment shown in FIG. 17.

FIG. 19 is a view showing the holder according to yet another embodiment of the present invention.

FIG. 20 is a cross section taken along XX-XX line in FIG. 19.

FIG. 21 is a perspective view showing a conventional holder.

### DETAILED DESCRIPTION OF VARIOUS EMBODIMENTS

An embodiment of the present invention will be described below with reference to the accompanying drawings.

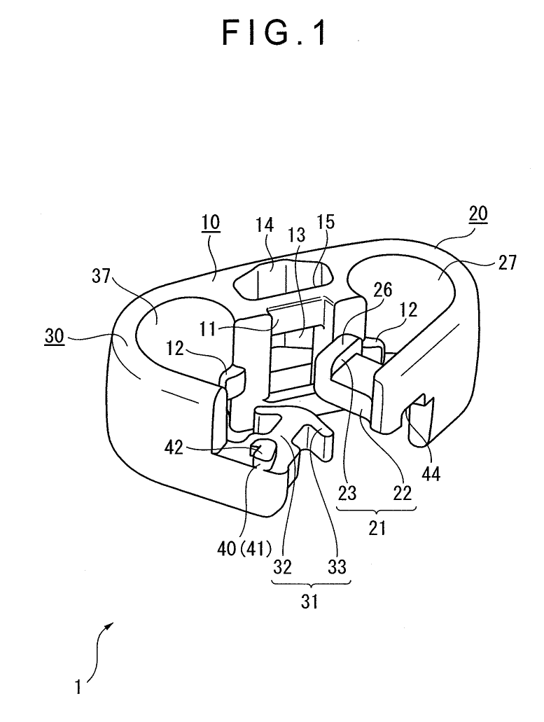

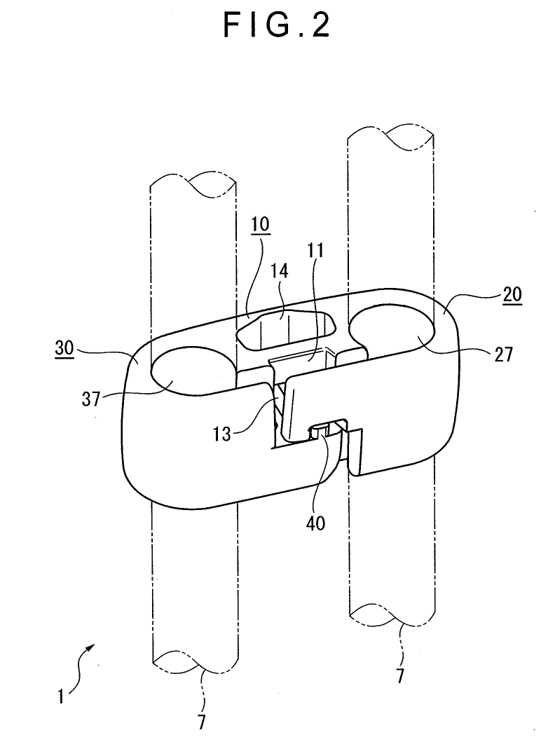

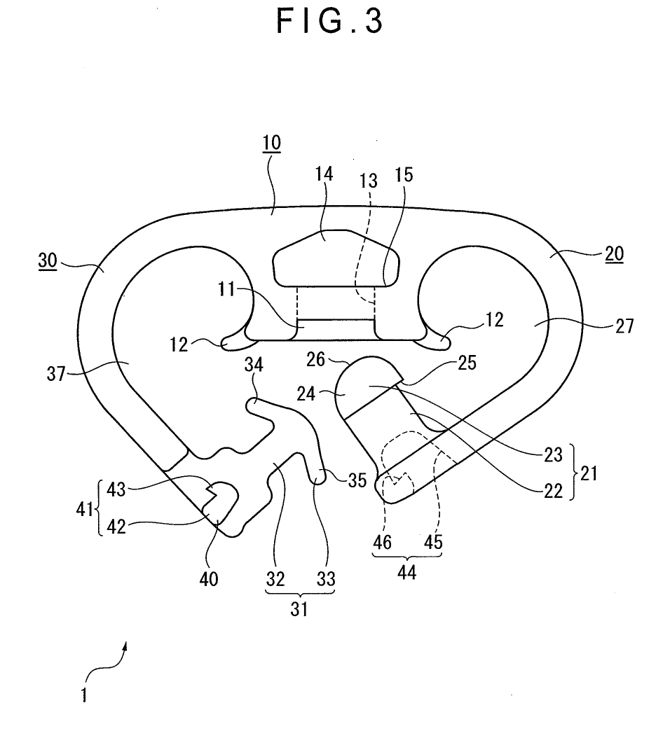

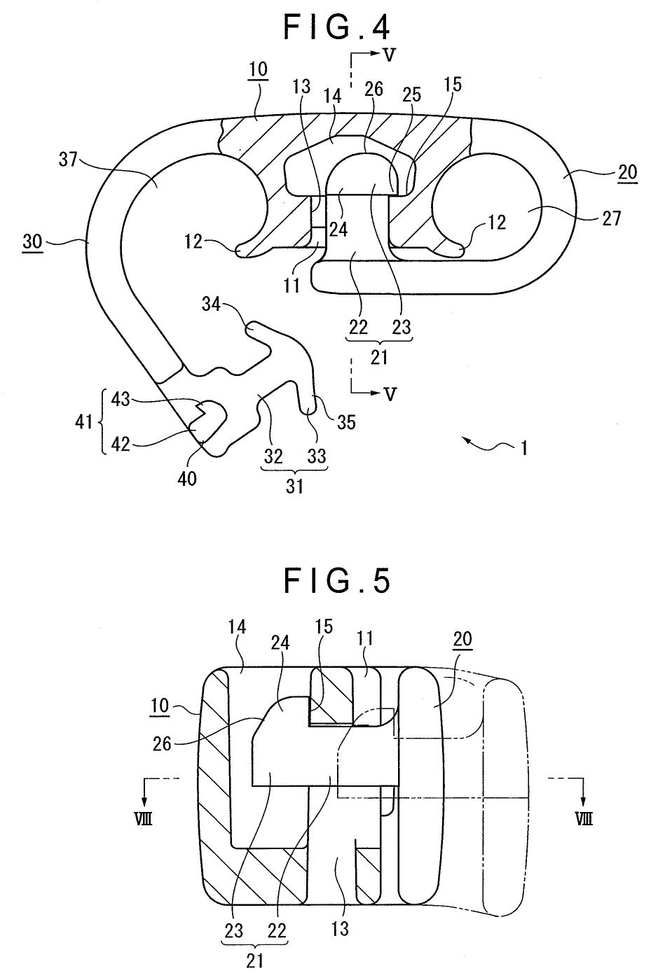

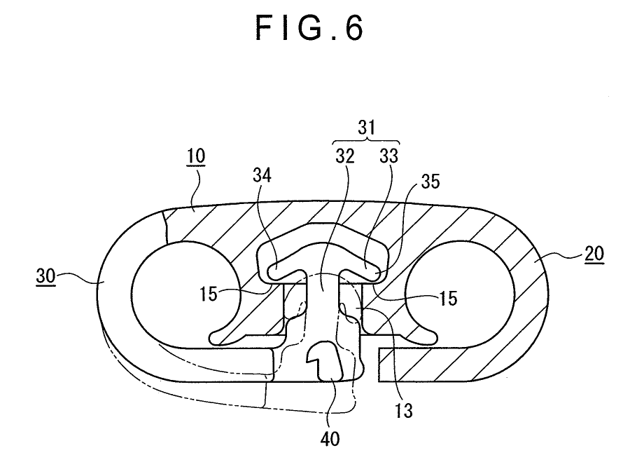

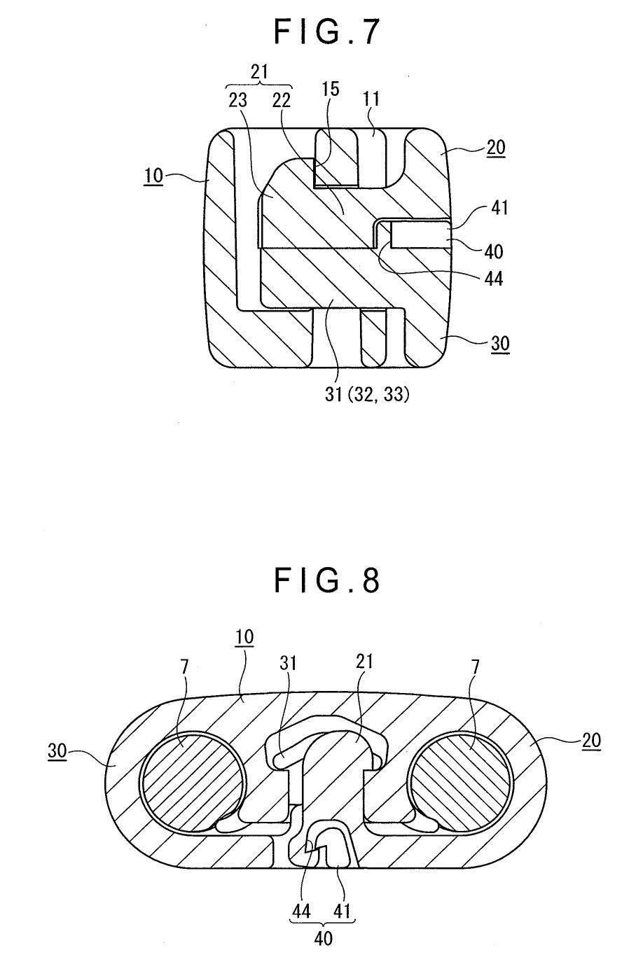

FIGS. 1-8 show a holder according to one embodiment of the present invention. FIG. 1 is a perspective view showing the holder before engagement. FIG. 2 is a perspective view showing the holder after engagement. FIG. 3 is a plan view showing the holder before engagement. FIG. 4 is a view showing a condition where one of bent portions (a first bent portion) of the holder is engaged from the condition of FIG. 3. FIG. 5 is a cross section taken along V-V line in FIG. 4. FIG. 6 is a partial cross section showing the holder in engagement. FIG. 7 is a central vertical cross section showing the holder. FIG. 8 is a cross section taken along VIII-VIII line in FIG. 5.

As shown in FIGS. 1-3, a holder 1 of the present embodiment is provided with a base 10, a first bent portion 20 which is extended from a first end (the right end in FIG. 1) of the base 10 and bendable relative to the base 10 and a second bent portion 30 which is extended from a second end (the left end in FIG. 1) of the base 10 and bendable relative to the base 10 so as to hold two strings 7 (objects to be held) in parallel. The base 10, the first bent portion 20 and the second bent portion 30 are integrally formed by injection molding or injection compression molding of synthetic resin materials.

As shown in FIG. 2, when the first bent portion 20 and the second bent portion 30 are engaged with the base 10, the profile shape viewed from the plan surface is shaped in an oval short column.

As shown in FIG. 3, when the first bent portion 20 and the second bent portion 30 are not engaged with the base 10, the first bent portion 20 and the second bent portion 30 are molded inclining inward and the first bent portion 20 inclines more inward than the second bent portion 30.

The base 10 is substantially rectangular-parallelepiped (a vertically long rectangular viewed from the front) in which the vertical dimension (height dimension) is larger than the horizontal dimension and the depth dimension.

A groove 11 that has the horizontal dimension of approximately half of that of the front surface of the base 10 is formed on the front surface of the base 10 opening from the lower portion (with respect to the vertical direction) at the upper surface. Guide claws 12 are integrally formed to be arc-shaped to project outward from the both sides of the base 10. A vertically long rectangular opening 13 is formed on the inner bottom surface of the groove 11 formed on the front surface of the base 10. A hole 14 is formed on a remote side of the opening 13. The hole 14 has the horizontal dimension larger than that of the opening 13 and opens at the upper surface of the base 10. Therefore, on a side of frame bodies forming the opening 13 that faces the hole 14, an engaging concave 15 is formed along the upper edge and right and left edges of the opening 13 as a first engaged element and a second engaged element. In other words, in the present embodiment, there is provided the engaging concave 15 that extends in four (i.e., up, down, right and left) directions since the frame bodies that form the opening 13 are rectangular-shaped.

The first bent portion 20 has a substantially even depth dimension and a vertical dimension arranged to be a belt-shape that has substantially the same dimension as the vertical dimension of the base 10. The first bent portion 20 is integrally formed from a first side surface of the base 10. At least one part of the first bent portion 20 is elastically deformable. Therefore, the first bent portion 20 is deformable relative to the base 10. Specifically, as shown in FIGS. 1 and 3, the first bent portion 20 is extended so that the depth becomes gradually thinner from the right side of the base 10 toward the right outside and is bent arc-shaped facing the front surface keeping the same thickness so as to be diagonally inclined toward the front center of the base 10.

The lower half (with respect to the vertical direction) of an end of the first bent portion 20 is cut to form a notch. The upper half is integrally formed with a first engaging element 21 engaged with the engaging concave 15 (the first engaged element) of the base 10 extending toward the base 10.

The first engaging element 21 is provided with a first stem 22 on the inner side of the end of the first bent portion 20 substantially orthogonally extending with respect to the end of the first bent portion 20 and a first engaging piece 23 on the end of the first stem 22 to be engaged with the engaging concave 15 of the base 10 extending beyond the cross section of the first stem 22, in other words, in a crossing direction with respect to the direction where the first stem 22 extends. The first stem 22 is rectangular in cross section. The first engaging piece 23 includes a first extending portion 24 that extends upward from the upper side of the first stem 22 and a second extending portion 25 that extends in a direction other than the direction where the first extending portion 24 extends, in other words, laterally extends from the side surface of the first stem 22. Briefly, the first engaging piece 23 is provided with the first extending portion 24 and the second extending portion 25 which extend in two or more different directions.

The first extending portion 24 and the second extending portion 25 are formed to have a thickness that prevents elastic deformation against the first stem 22. An end surface 26 of the first engaging piece 23 that includes the first extending portion 24 and the second extending portion 25 is formed substantially semicircular (viewed from plan surface, see FIGS. 3 and 4) on an inclining surface that gradually inclines toward the first stem 22 upward from the middle position of the vertical direction. Therefore, when the first engaging element 21 is inserted into the opening 13 of the base 10, the end surface 26 of the first engaging piece 23 abuts the upper edge and the side edges of the opening 13, so that the first engaging portion 21 is shifted to the lower side, in other words, the first bent portion 20 is elastically deformed to the lower side. After this, while the first extending portion 24 and the second extending portion 25 pass through the frame bodies that form the opening 13, the first bent portion 20 elastically deformed downwards recovers to the original attitude (the upper position) to allow the engagement of the first extending portion 24 and the second extending portion 25 of the first engaging piece 23 with the engaging concave 15 (the first engaged element). When the first extending portion 24 and the second extending portion 25 of the first engaging piece 23 are engaged with the engaging concave 15 (the first engaged element), a substantially circular first accommodating space 27 is formed by a side surface of the base 10, the guide claw 12 and the inner circumference of the first bent portion 20. The strings 7 are held within this first accommodating space 27.

The second bent portion 30 has a substantially even depth dimension and a vertical dimension arranged to be a belt-shape that has substantially the same dimension as the vertical dimension of the base 10. The first bent portion 20 is integrally formed from a first side surface of the base 10. At least a part of the first bent portion 20 is elastically deformable. Therefore, the second bent portion 30 is also deformable relative to the base 10. Specifically, as shown in FIGS. 1 and 3, the first bent portion 20 is extended so that the depth becomes gradually thinner from the left side of the base 10 toward the left outside and is bent to be arc-shaped facing the front surface keeping the same thickness so as to be diagonally inclined toward the front center of the base 10.

The upper half (with respect to the vertical direction) of an end of the second bent portion 30 is cut to form a notch. The lower half is integrally formed with a second engaging element 31 engaged with the engaging concave 15 (the second engaged element) extending toward the base 10.

The second engaging element 31 is provided with a second stem 32 on the inner side of the end of the second bent portion 30 substantially orthogonally extending with respect to the end of the second bent portion 30 and a second engaging piece 33 on the end of the second stem 32 to be engaged with the engaging concave 15 of the base 10 extending beyond of the cross section of the end of the second stem 32, in other words, in a crossing direction with respect to the direction where the second stem 32 extends. The second stem 32 is formed to have rectangular cross-section. An end of the second stem 32 is formed to have further smaller rectangular cross section. The second engaging piece 33 is provided with two arrow-tip shaped extending portions 34 and 35 that horizontally extend from the both sides of the second stem 32. Therefore, seeing from the first engaging piece 23, the first engaging piece 23 includes the extending portion 24 that extends in a crossing direction relative to the extending directions of the extending portions 34 and 35 of the second engaging piece 33, in other words, toward the upper side of the first stem 22.

The extending portions 34 and 35 have a thickness that allows elastic deformation against the second stem 32. Therefore, when the second engaging element 31 is inserted into the opening 13 of the base 10, the extending portions 34 and 35 abut the right and left side edges of the opening 13 so that the extending portions 34 and 35 pass through the frame bodies that form the opening 13. At the same time, the elastically deformed extending portions 34 and 35 recovers the original shape (see FIG. 6), so that the extending portions 34 and 35 of the second engaging piece 33 are engaged with the engaging concave 15 (the second engaged element). When the second engaging element 31 is engaged with the engaging concave 15 (the second engaged element), a substantially circular second accommodating space 37 is formed by a side surface of the base 10, the guide claw 12 and the inner circumference of the second bent portion 30. The string 7 is held within this second accommodating space 37.

When each of the first engaging element 21 and the second engaging element 31 is engaged respectively with the engaging concave 15 (the first engaged element and the second engaged element) of the base 10, the first engaging element 21 and the second engaging element 31 are located adjacently with each other (FIG. 7). In other words, the first engaging element 21 and the second engaging element 31 are located adjacently (or substantially adjacently) in the central axial (vertical) direction of at least one of the first accommodating space 27 and the second accommodating space 37.

A movement stopper 40 is provided on the end portion of the second bent portion 30, which prevents the first engaging element 21 from moving toward the disengaging direction.

The movement stopper 40 is constituted by a third engaged element 44 provided on the first bent portion 20 and a third engaging element 41 provided on the second bent portion 30 to be engaged with the third engaged portion 44, which are provided on a surface where the first engaging element 21 and the second engaging element 31 face with each other.

The third engaging element 41 is formed by a convex 42 that projects along the axial direction of the second stem 32 of the second engaging element 31. A laterally-projecting hook 43 is provided on an end of the convex 42.

The third engaged element 44 is constituted by a concave 45 to be engaged with the convex 42 of the third engaging element 41 and is placed between the first engaging element 21 and the third engaging element 41 in the direction where the first engaging element 21 is disengaged. The concave 45 includes a hooking groove 46 engaged with the hook 43 of the convex 42.

In such an arrangement, after the strings 7 are placed inside of the first bent portion 20 and the second bent portion 30, the first bent portion 20 and the second bent portion 30 are bent to be engaged with the base 10.

At this time, the first bent portion 20 and the second bent portion 30 are elastically deformable and made of synthetic resin while being formed inclining inward with each other, so that the first bent portion 20 and the second bent portion 30 can be easily bent with respect to the base 10. Further, the second bent portion 30 can be subsequently bent after the first bent portion 20 is initially bent since the first bent portion 20 is inclined more inward than the second bent portion 30. As a result, when there is an assembly sequence such as that of the present embodiment, the assembly operation can be done without mistaking the assembly steps.

Firstly, the first bent portion 20 is elastically deformed with respect to the base 10 so that the first engaging element 21 provided on the first bent portion 20 is engaged with the engaging concave 15 through the opening 13 of the base 10. At this time, since the first engaging element 21 extends from the end of the first bent portion 20 toward the base 10, it is only necessary to bend the first bent portion 20 to be elastically deformed with respect to the base 10.

When the first engaging piece 23 of the first engaging element 21 is inserted into the opening 13 of the base 10, the end surface 26 of the first engaging piece 23 abuts to the upper and side edges of the opening 13 so that the first engaging element 21 is shifted to the lower side by the end surface 26. In other words, the first bent portion 20 is elastically deformed to the lower side so that the first engaging piece 23 is engaged with the engaging concave 15 (the first engaged element) through the opening 13.

When the first engaging element 23 is engaged with the engaging concave 15 (the first engaged element), the substantially circular first accommodating space 27 is formed by a side surface of the base 10, the guide claw 12 and the inner circumference of the first bent portion 20. The string 7 is held within the first accommodating space 27.

At this time, since the first engaging piece 23 has a thickness that prevents elastic deformation so that the first engaging piece 23 is not likely to be disengaged from the engaging concave 15 by elastic deformation of the first engaging piece 23.

Next, the second bent portion 30 is elastically deformed with respect to the base 10 so that the second engaging element 31 provided on the second bent portion 30 is engaged with the engaging concave 15 through the opening 13 of the base 10. At this time, since the second engaging element 31 extends from the end of the second bent portion 30 toward the base 10, it is only necessary to bend the second bent portion 30 with respect to the base 10 to be elastically deformed in the central direction.

When the second engaging piece 33 of the second engaging element 31 is inserted into the opening 13 of the base 10, the extending portions 34 and 35 that constitute the second engaging piece 33 abut to the left and right edges of the opening 13 to be elastically deformed so that the second engaging piece 33 is engaged with the engaging concave 15 (the second engaged element) through the opening 13.

When the second engaging element 33 is engaged with the engaging concave 15 (the second engaged element), the substantially circular second accommodating space 37 is formed by a side surface of the base 10, the guide claw 12 and the inner circumference of the second bent portion 30. The string 7 is held within the second accommodating space 37. As above, even a ring-shaped looped string can be held.

At this time, the second engaging element 31 vertically abuts to the first engaging element 21 so as to work as a movement stopper that prevents the first bent portion 20 to be elastically deformed in a direction where the first engaging element 21 is disengaged.

In other words, since the second engaging element 31 abuts to the first engaging element 21 when the first engaging element 21 and the second engaging element 31 are engaged with the engaging concave 15 of the base 10, the first bent portion 20 is prevented from elastically deforming in a direction where the first engaging element 21 is disengaged. Accordingly, the second engaging element 31 works as a movement stopper that prevents the elastic deformation of the first bent portion 20 in a direction where the first engaging element 21 is disengaged.

As above, when the first engaging element 21 and the second engaging element 31 are engaged with the engaging concave 15 of the base 10, the first engaging piece 23 of the first engaging element 21 is formed to have a thickness that prevents elastic deformation and, consequently, easy detachment. The first extending portion 24 and the second extending portion 25 of the first engaging piece 23 laterally extend upward. The extending portions 34 and 35 of the second engaging piece 33 extend in the horizontal direction. In other words, since the first extending portion 24 and the second extending portion 25 of the first engaging piece 23 are engaged with the engaging concave 15 of the base 10 in two different directions that are different from those of the extending portions 34 and 35 of the second engaging piece 33, the first extending portion 24 and the second extending portion 25 are less likely to be disengaged even with external force in various directions and the string 7 can be thus securely held.

Especially, in such an arrangement, since the first engaging piece 23 and the second engaging piece 33 can share directions of the applied external force, the first engaging piece 23 and the second engaging piece 33 can be respectively designed in a shape and a configuration which meet the required functions to enhance design flexibility.

Further, in the present embodiment, apart from the second engaging element 31 that works as a movement stopper for the first engaging element 21, the second bent portion 30 is provided with the movement stopper 40 that prevents the first engaging element 21 from moving in a disengaging direction. Therefore, each of the engaging elements 21 and 31 are less likely to be popped out and the holding force can be enhanced.

For example, when an external force in a direction where the first engaging element 21 is disengaged is applied on the first bent portion 20 via the string 7, the external force is applied also on the engaging portion of the second engaging element 31 provided on the second bent portion 30 and the engaging concave 15 provided on the base 10 via the movement stopper 40 while being applied on the engaging portion of the first engaging element 21 provided on the first bent portion 20 and the engaging concave 15 provided on the base 10. Since the first engaging element 21 and the second engaging element 31 can cooperatively share the external force to hold the strings 7, the first engaging element 21 and the second engaging element 31 are less likely to be popped out. Therefore, the holding force can be enhanced.

Further, since the movement stopper 40 is constituted by the concave 45 provided on the first bent portion 20 and the convex 42 provided on the second bent portion 30, for example, the concave 45 provided on the first bent portion 20 abuts to the convex 42 provided on the second bent portion 30 to restrict the movement of the first bent portion 20 when the first bent portion 20 is moved in a direction where the first engaging portion 21 is disengaged by external force applied on the first bent portion 20 via the string 7. At this time, since the concave 45 is placed between the first engaging element 21 and the convex 42 in a direction where the first engaging element 21 is disengaged, no torsion is generated on the first bent portion 20 even when the concave 45 abuts to the convex 42 provided on the second bent portion 30. Therefore, the external force is distributed to the second bent portion 30 via the convex 42.

In addition, since the first engaging element 21 and the second engaging element 31 are formed at a neighboring position in the central axial direction of the first and second accommodating spaces 27 and 37 and the third engaging element 41 and the third engaged element 44 are formed on a surface where the first engaging element 41 and the second engaging element 31 are opposed to each other, i.e., since engaging portions are provided at one position all together, engaging operations can be done at the one position and a compact structure can be realized. Further, since engaging portions are not dispersed, shakiness of each portion can be reduced to enhance the overall strength.

The present invention is not limited to the embodiment of the holder 1 of the structure described above in relation to FIGS. 1-8, but may include modifications, such as those described in relation to the following embodiments. In the description of the following alternative embodiments, the same components as of the above embodiment will be denoted by like numerals, and explanations thereof will be omitted or simplified.

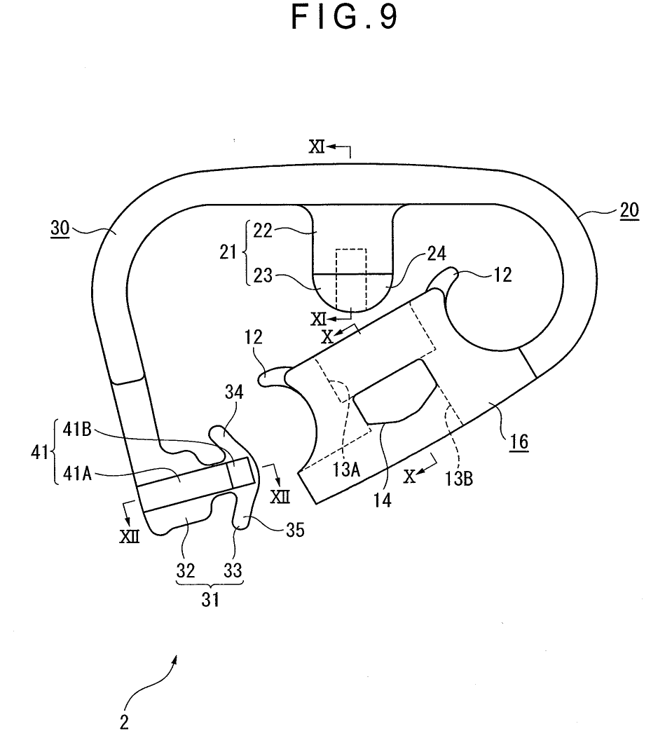

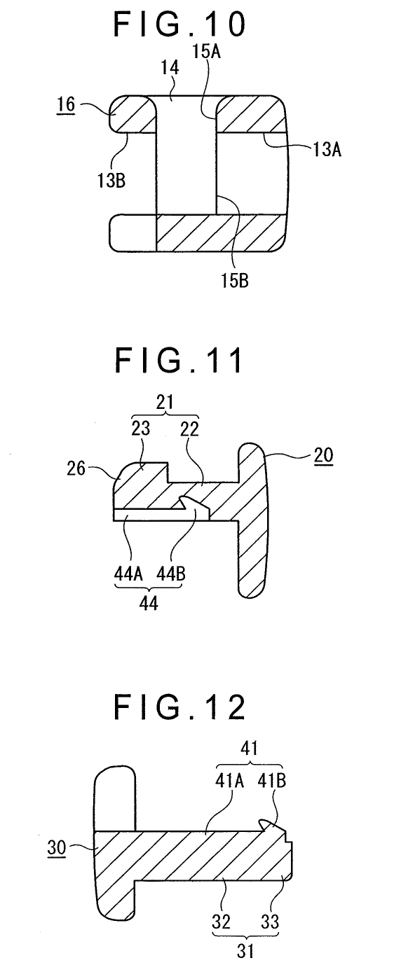

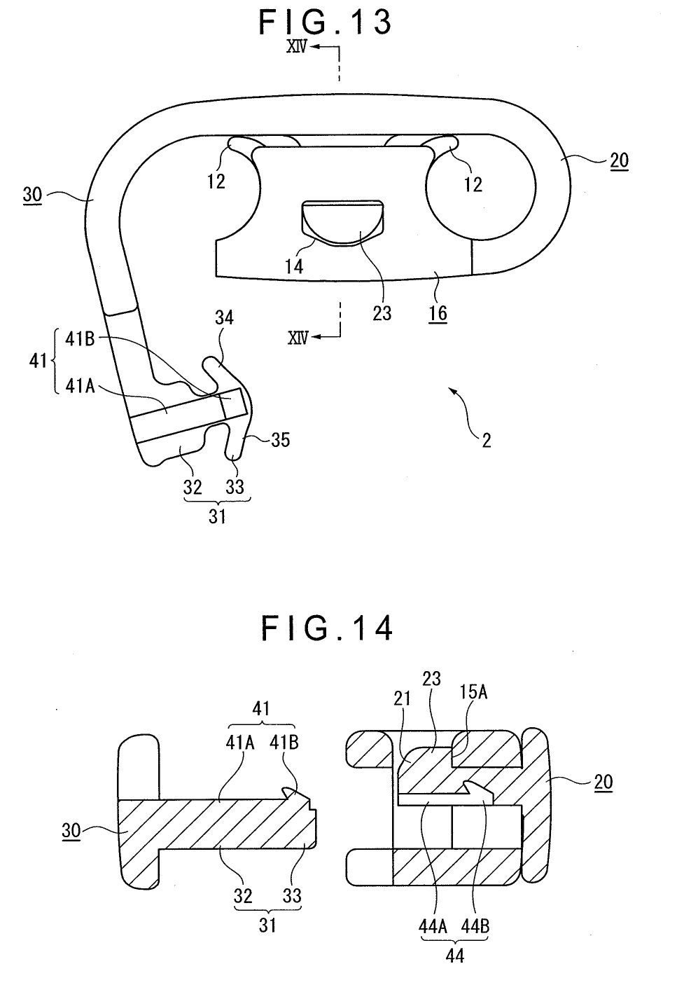

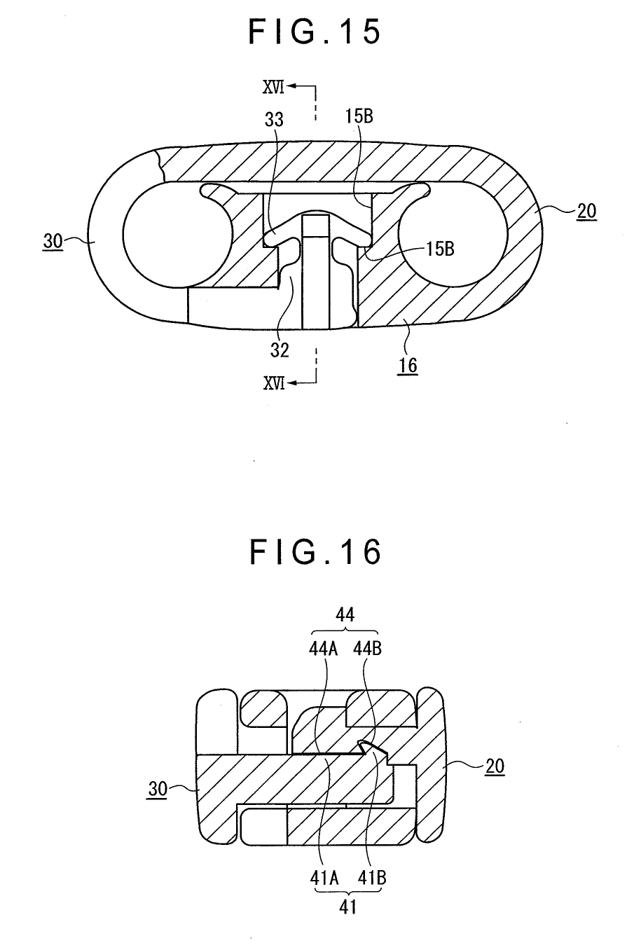

FIG. 9 is a plan view showing the holder 2 before engagement according to an alternative embodiment. FIG. 10 is a cross section taken along X-X line in FIG. 9. FIG. 11 is a cross section taken along XI-XI line in FIG. 9. FIG. 12 is a cross section taken along XII-XII line in FIG. 9. FIG. 13 is a view showing a condition in which one bent portion (a first bent portion) of the holder 2 is engaged. FIG. 14 is a cross section taken along XIV-XIV line in FIG. 13. FIG. 15 is a partial cross section showing the holder 2 after engagement. FIG. 16 is a cross section taken along XVI-XVI line in FIG. 15.

The holder 2 in the embodiment shown in FIGS. 9-16 is different from the holder 1 of the above embodiment by the point that a second bent portion 30 is extended from a first end of the first bent portion 20. In other words, although the second bent portion 30 and the first bent portion 20 are provided on the both sides of the base 10 in the above embodiment, a base (an engaged portion 16) extends as the first bent portion 20 and further as the second bent portion 30 in this alternative embodiment. Relating thereto, arrangements that correspond to the base 10, the first engaging element 21, the second engaging element 31 and the third engaging element 41 of the above embodiment are partially different.

The first bent portion 20 is provided with the engaged portion 16 that corresponds to the base 10 of the above embodiment. The engaged portion 16 (the base) protrudes from an inner end of the first bent portion 20. An opening 13A that is in communication with a hole 14 is provided on an protruded end surface of the engaged portion 16 while an opening 13B that is in communication with the hole 14 is also provided on a back surface. The horizontal dimension of the opening 13A is formed larger than that of the hole 14. On the inner bottom surface of the opening 13A, an engaging concave 15B (a second engaged element, see FIG. 10) is formed along the outer circumferential edge of the opening 13A and an engaging concave 15A (a first engaged element) is formed on the upper surface of the hole 14.

A first engaging element 21 is constituted by: a first stem 22 that protrudes from the middle position of the first bent portion 20 and the second bent portion 30; and a first engaging piece 23 that has, on the end of the first stem 22, a first extending portion 24 extended in the crossing direction with respect to the direction where the first stem 22 protrudes. A third engaged element 44 is formed on the lower surface of the first stem 22. The third engaged element 44 is constituted by a groove 44A formed along the lower side of the first stem 22 and an engaging groove 44B formed on the end of the groove 44A.

A second engaging element 31 is constituted by a second stem 32 that protrudes from the end of the second bent portion 30 and a second engaging piece 33 that has, on the end of the second stem 32, two extending portions 34 and 35 extended in the crossing direction with respect to the direction where the second stem 32 protrudes.

A third engaging element 41 is constituted by a convex tread 41A protruded on the upper surface of the second bent portion 30 and the second stem 32 along the axial direction of the second stem 32 and a securing projection 41B protruded at a first end of the convex 41A in hook-shape.

In the above arrangement, as shown in FIGS. 13 and 14, the first bent portion 20 is elastically deformed firstly so that the first engaging piece 23 of the first engaging element 21 is engaged with the engaging concave 15A (the first engaged element) of the engaged portion 16.

Then, as shown in FIGS. 15 and 16, the second bent portion 30 is elastically deformed so that the second engaging piece 33 of the second engaging element 31 is engaged with the engaging concave 15B (the second engaged element) of the engaged portion 16. Accordingly, the convex tread 41A and the securing projection 41B of the third engaging element 41 are engaged with the groove 44A and the engaging groove 44B of the third engaged element 44 without a gap. Thus, in the engagement, assembly with less shakiness is possible.

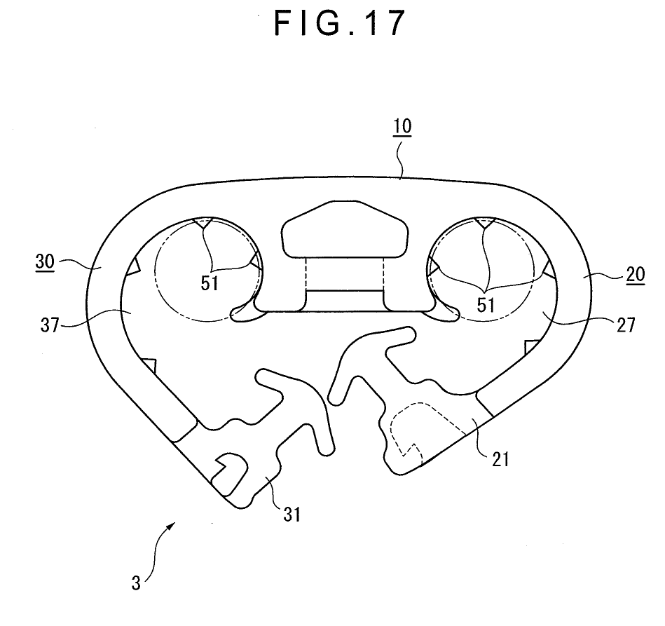

FIG. 17 shows a holder 3 according to another embodiment. FIG. 17 is a plan view showing the holder 3 before engagement.

A first engaging element 21 and a second engaging element 31 have the same shape in the holder 3 of the embodiment shown in FIG. 17. In other words, the holder 3 of the embodiment shown in FIG. 17 is different from the above embodiment in that the second engaging element 31 described in the above embodiment is adapted to the first engaging element 21 and the second engaging element 31.

Further, each of the inner circumferences of a first accommodating space 27 and a second accommodating space 37 is respectively provided with a triangular projection 51 that projects toward the inner space of each of the accommodating spaces by a constant interval. In the above embodiment, movement of the string 7 in the longitudinal direction was not restricted. In this embodiment, a string 7 can be more securely held.

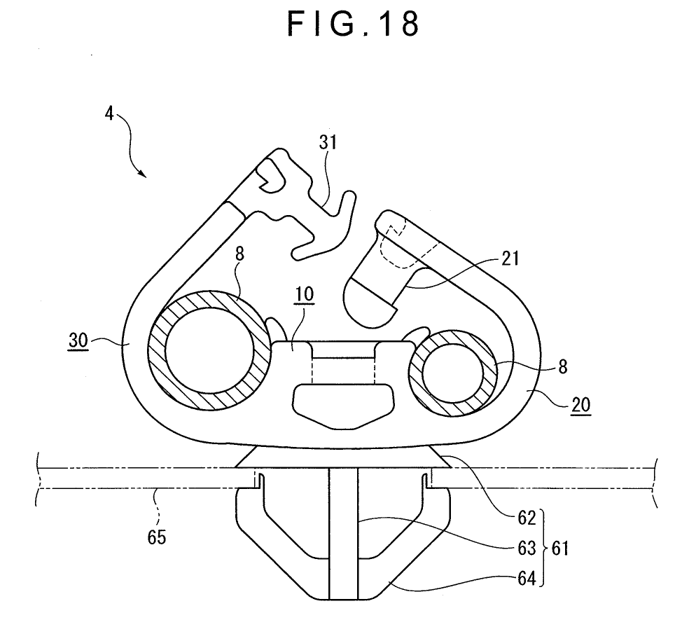

FIG. 18 shows a holder 4 according to yet another embodiment. FIG. 18 is a plan view showing the holder 4 before engagement.

The holder 4 shown in FIG. 18 is provided with a securing tool 61 on a base 10 of the holder 4. The securing tool 61 is constituted by an abutment member 62 integrally formed on a back side of the base 10, a column 63 that projects from the center of the abutment member 62 and an elastic piece 64 that extends to a first end of the column 63 keeping a predetermined gap with respect to the abutment member 62.

When the holder 4 is engaged with a fixed object 65 such as a vehicle body by using the abutment member 62 and the elastic piece 64 of the securing tool 61, an object to be held such as a cord 8 can be held along a surface of the vehicle body.

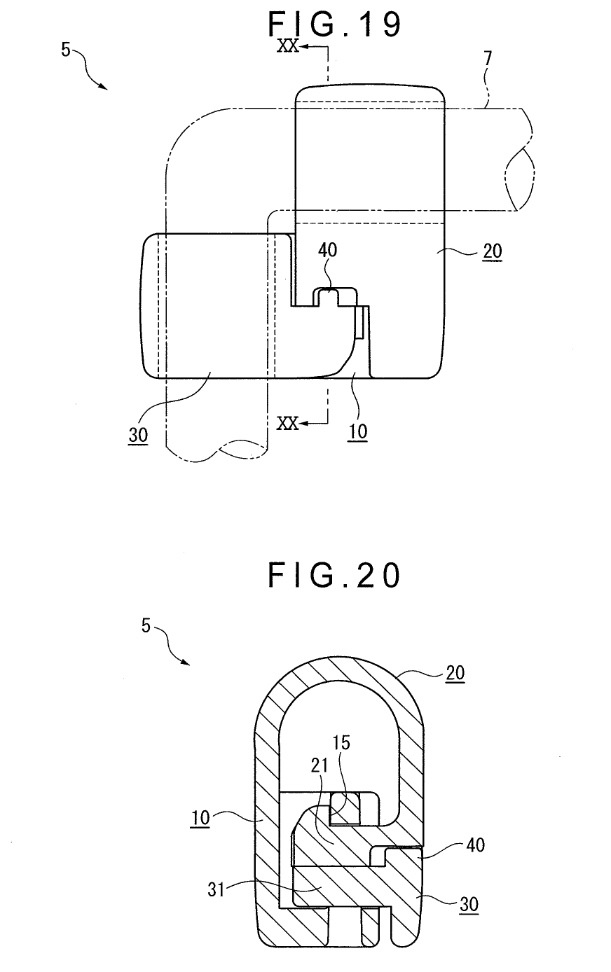

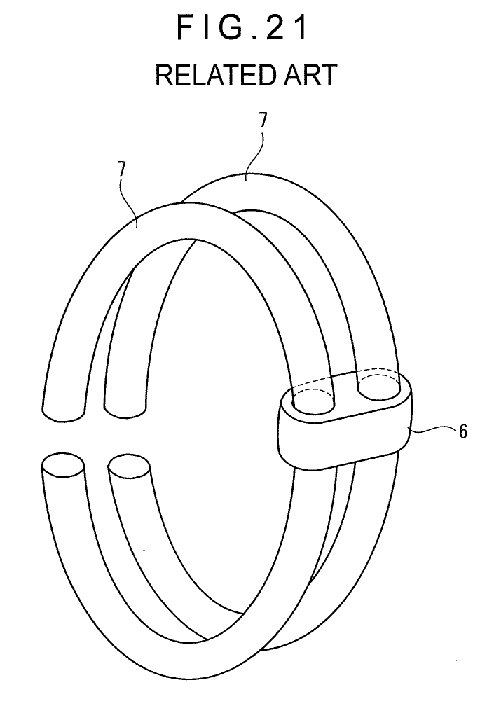

FIGS. 19 and 20 show a holder 5 according to another embodiment. FIG. 19 is a side view showing the holder 5. FIG. 20 is a cross section taken along XX-XX line in FIG. 19.

In the holder 5 of the embodiment shown in FIGS. 19 and 20, a first bent portion 20 and a second bent portion 30 are bent from a base 10 orthogonally crossing with each other so that a first engaging element 21 and a second engaging element 31 which are provided on each first end of the first engaging element 21 and the second engaging element 31 are engaged with the same side of the base 10.

In this arrangement, the first bent portion 20 and the second bent portion 30 can hold a string 7 (an object to be held) while being bent.

Although the base 10, the first bent portion 20 and the second bent portion 30 are integrally formed by synthetic resin materials in the above embodiments, various alternative embodiments are not limited to this. For example, metal materials can be used instead.

Further, although the first bent portion 20 and the second bent portion 30 are elastically deformed to be bendable with respect to the base 10 in the above embodiments, various alternative embodiments are not limited to this. For example, applying a hinge to the base 10 to realize the bendability is also possible.

In one or more of the above embodiments, the second engaging element 31 itself works as a movement stopper for the first engaging element 21. In addition, the movement stopper 40 is constituted by the third engaging element 41 provided on the end of the second bent portion 30 and the third engaged element 44 provided on the end of the first bent portion 20. However, various alternative embodiments are not limited to these. For example, a convex may be provided on the second bent portion 30 so that the convex abuts to an outer surface (both of a concave and a plane surface are possible) of the first bent portion 20.

In addition, a position to be provided with the movement stopper 40 is not limited to the second bent portion 30 but may be the second engaging element 31 according to various embodiments.

Although the movement stopper 40 that prevents the first engaging element 21 from moving toward a disengaging direction is provided in the above embodiments, substantially the same advantage can be expected without providing the movement stopper 40 according to other embodiments.

Further, although the third engaging element 41 is made to be the convex 42 and the third engaged element 44 is made to be the concave 45 in the above embodiments, these can be vice versa according to other various embodiments. Specifically, the third engaging element 41 may be the concave and the third engaged element 44 may be the convex.

The priority application number JP 2007-128028 upon which this patent application is based is hereby incorporated by reference.

What is claimed is:

1. A holder, comprising:
a base that comprises a first engaged element and a second engaged element;
a first bent portion that extends from a first end of the base and is bendable with respect to the base; and
a second bent portion that extends from a second end of the base or the first bent portion and is bendable with respect to the base, wherein:
the first bent portion comprises a first engaging element that is engaged with the first engaged element of the base;
the second bent portion comprises a second engaging element that is engaged with the second engaged element of the base;
the first engaging element is engaged with the first engaged element to provide a first accommodating space within which an object is held by the base and the first bent portion;
the second engaging element is engaged with the second engaged element to provide a second accommodating space within which an object is held by the base and the second bent portion; and
at least one of the second bent portion and the second engaging portion comprises a movement stopper that prevents the first engaging element from moving in a disengaging direction.

2. The holder according to claim 1, wherein:
the movement stopper comprises a third engaged element that is provided on the first bent portion and a third engaging element that is provided on the second bent portion and engaged with the third engaged element;
one of the third engaged element and the third engaging element is formed by a convex and the other is formed by a concave that is engaged with the convex; and
the convex and the concave are placed adjacently in the disengaging direction of the first engaging element.

3. The holder according to claim 2, wherein:
the base is provided with an opening and an engaging concave is formed on a remote side of the opening;
the first engaged element and the second engaged element are formed by the engaging concave;
the first engaging element comprises a first stem that protrudes on a distal end of the first bent portion and a first engaging piece that extends on a distal end of the first stem in a crossing direction with respect to the direction where the first stem protrudes to engage with the engaging concave; and
the second engaging element comprises a second stem that protrudes on a distal end of the second bent portion and a second engaging piece that extends on a distal end of the second stem in a crossing direction with respect to the direction where the second stem protrudes to engage with the engaging concave.

4. The holder according to claim 3, wherein
at least one of the first engaging piece and the second engaging piece comprises an extending portion that extends in two or more different directions.

5. The holder according to claim 4, wherein
the first engaging piece comprises an extending portion that extends in a crossing direction with respect to the extending direction of the second engaging piece.

6. The holder according to claim 3, wherein
when the first engaging element and the second engaging element are respectively engaged with the first engaged element and the second engaged element, the first engaging element and the second engaging element are located adjacently with each other,
the first engaging element is engaged with the first engaged element by elastic deformation of the first bent portion, and
the second engaging element is engaged with the second engaged element by elastic deformation of the second engaging piece.

7. The holder according to claim 6, wherein
the first engaging element and the second engaging element are formed adjacently in a central axial direction of at least one of the first accommodating space and the second accommodating space.

8. The holder according to claim 6, wherein
a third engaging element and a third engaged element are provided on a surface where the first engaging element and the second engaging element face to each other.

9. The holder according to claim 1, wherein:
the second bent portion extends from a second end of the base; and
the first bent portion and the second bent portion are molded inclining inward with each other and the first bent portion is molded inclining more inward than the second bent portion.

10. The holder according to claim 9, wherein
the first engaging element and the second engaging element extend toward the base respectively from each distal end of the first bent portion and the second bet portion.
